(19) United States
(12) Patent Application Publication
(10) Pub. No.: US 2024/0422731 A1
(43) Pub. Date: Dec. 19, 2024

(54) SIDELINK COOPERATIVE POSITIONING IN NLOS SCENARIO

(71) Applicant: Lenovo (Singapore) Pte. Ltd., New Tech Park (SG)

(72) Inventors: Abir Ben Hadj Fredj, Frankfurt am main (DE); Robin Thomas, Bad Nauheim (DE); Karthikeyan Ganesan, Kronberg im Taunus (DE); Vijay Nangia, Woodridge, IL (US); Colin Frank, Park Ridge, IL (US)

(21) Appl. No.: 18/700,502

(22) PCT Filed: Oct. 11, 2022
(86) PCT No.: PCT/IB2022/059760

§ 371 Date: Apr. 11, 2024

Related U.S. Application Data
(60) Provisional application No. 63/254,364, filed on Oct. 11, 2021.

(51) Int. Cl. H04W 64/00; H04W 24/10

(52) U.S. Cl. CPC H04W 64/006; H04W 24/10

(57) ABSTRACT

Apparatuses, methods, and systems are disclosed for SL cooperative positioning in NLOS scenario. An apparatus (1200) includes a memory (1210) and a processor (1205) coupled to the memory. The processor (1205) is configured to cause the apparatus (1200) to transmit a cooperative positioning request message to at least one reference device comprising a ranging or relative positioning request between the apparatus and a target device. The processor (1205) is configured to cause the apparatus (1200) to receive at least one positioning quantity from the at least one reference device. The processor (1205) is configured to cause the apparatus (1200) to determine ranging or relative position between the at least one reference device and the target device based on the received at least one positioning quantity.

### CROSS-REFERENCE TO RELATED APPLICATIONS

This application claims priority to U.S. Provisional Patent Application No. 63/254,364 entitled “SL COOPERATIVE POSITIONING IN NLOS SCENARIO” and filed on Oct. 11, 2021, for Abir Ben Hadj Fredj, et al., which is incorporated herein by reference.

### FIELD

The subject matter disclosed herein relates generally to wireless communications and more particularly relates to sidelink (“SL”) cooperative positioning in non-line of sight (“NLOS”) scenario.

### BACKGROUND

In wireless networks, although there exists a 3GPP positioning framework, which enables UE-assisted and UE-based positioning methods, there is currently a lack of support and specification for efficient relative positioning procedures or UE-to-UE range/orientation determination, which is essential to support relative positioning applications across different vertical services, e.g., V2X, Public Safety, IIoT, Commercial, etc.

### BRIEF SUMMARY

Disclosed are solutions for SL cooperative positioning in NLOS scenario. The solutions may be implemented by apparatus, systems, methods, or computer program products.

In one embodiment, a first apparatus includes a memory and a processor coupled to the memory. In one embodiment, the processor is configured to cause the apparatus to transmit a cooperative positioning request message to at least one reference device comprising a ranging or relative positioning request between the apparatus and a target device. In one embodiment, the processor is configured to cause the apparatus to receive at least one positioning quantity from the at least one reference device. In one embodiment, the processor is configured to cause the apparatus to determine ranging or relative position between the at least one reference device and the target device based on the received at least one positioning quantity.

In one embodiment, a first method transmits a cooperative positioning request message to at least one reference device comprising a ranging or relative positioning request between the apparatus and a target device. In one embodiment, the first method receives at least one positioning quantity from the at least one reference device. In one embodiment, the first method determines ranging or relative position between the at least one reference device and the target device based on the received at least one positioning quantity.

In one embodiment, a second apparatus includes a memory and a processor coupled to the memory. In one embodiment, the processor is configured to cause the apparatus to receive a cooperative positioning request message from a network device comprising a ranging or relative positioning request between the network device and a target device. In one embodiment, the processor is configured to cause the apparatus to transmit at least one positioning quantity to the network device for determining ranging or relative position between the at least one reference device and the target device based on the received at least one positioning quantity.

In one embodiment, a second method receives a cooperative positioning request message from a network device comprising a ranging or relative positioning request between the network device and a target device. In one embodiment, the second method transmits at least one positioning quantity to the network device for determining ranging or relative position between the at least one reference device and the target device based on the received at least one positioning quantity.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for SL cooperative positioning in NLOS scenario;

FIG. 2 depicts a diagram illustrating one embodiment of a NR protocol stack

FIG. 3 depicts an overview on absolute and relative positioning as defined in Stage 1 specifications;

FIG. 4 depicts a multi-Cell RTT Procedure;

FIG. 5 depicts a relative range estimation using the existing single gNB RTT positioning framework;

FIG. 6 depicts NR Beam-based Positioning;

FIG. 7 depicts DL-TDOA Assistance Data;

FIG. 8 depicts DL-TDOA Measurement Report;

FIG. 9 depicts a network setup showing the reference UE, initiator UE, and the responder UE;

FIG. 10 depicts a cooperative positioning scenario based on poor quality/NLOS links;

FIG. 11 depicts a cooperative positioning signaling procedure for a partial coverage scenario;

FIG. 12 is a block diagram illustrating one embodiment of a user equipment apparatus that may be used for SL cooperative positioning in NLOS scenario;

FIG. 13 is a block diagram illustrating one embodiment of a network apparatus that may be used for SL cooperative positioning in NLOS scenario;

FIG. 14 is a flowchart diagram illustrating one embodiment of a method for SL cooperative positioning in NLOS scenario; and

FIG. 15 is a flowchart diagram illustrating one embodiment of a method for SL cooperative positioning in NLOS scenario.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for SL cooperative positioning in NLOS scenario. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Although there exists a 3GPP positioning framework, which enables UE-assisted and UE-based positioning methods, there is currently a lack of support and specification for efficient relative positioning procedures or UE-to-UE range/orientation determination, which is essential to support relative positioning applications across different vertical services, e.g., V2X, Public Safety, IIoT, Commercial, etc. The recently completed 3GPP RAN study item RP-201272, incorporated herein by reference, has outlined the use cases, requirements, and operational scenarios for performing positioning in in-coverage, partial coverage and out-of-coverage scenarios for V2X and Public Safety in TR 38.845, incorporated herein by reference. Furthermore, relative positioning (including ranging) performance requirements have been further outlined for commercial and IIoT use cases in TS22.261 and TS22.104.

This disclosure addresses the issues and challenges related NLOS scenarios, where the link between a target-UE and other UE(s) is poor and therefore resulting in a low absolute and relative accuracy positioning estimate. More specifically, the following challenges are addressed:
Overcoming the issue of accuracy degradation of relative positioning/ranging between UEs due to multipath and NLOS by studying cooperative sidelink positioning procedure considering UE-assisted (network-calculates the final estimates) and UE-based (UE calculates the final estimates):
Triggering and detection of a link or set of PC5 links that is deemed to be NLOS/blocked/poor link quality including measurement metrics.
Procedures for initiating a cooperative positioning session involving reference UEs, given that the link has been deemed to be NLOS/blocked/poor link quality.
Enabling reference UEs to assist in supporting NLOS positioning using configured SL-RAT/RAT-independent positioning methods

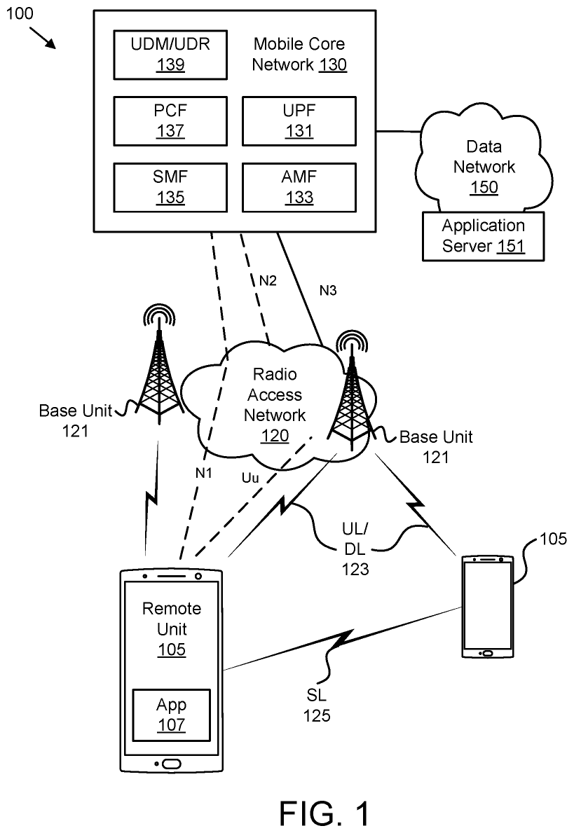

FIG. 1 depicts a wireless communication system 100 supporting SL cooperative positioning in NLOS scenario, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130. In one embodiment, remote units 105 may communicate over a sidelink connection 125. As used herein, sidelink is a topology of the system 100 that enables direct communication between two devices without the participation of a base station in the transmission and reception of data traffic.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “‘attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”), a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems.

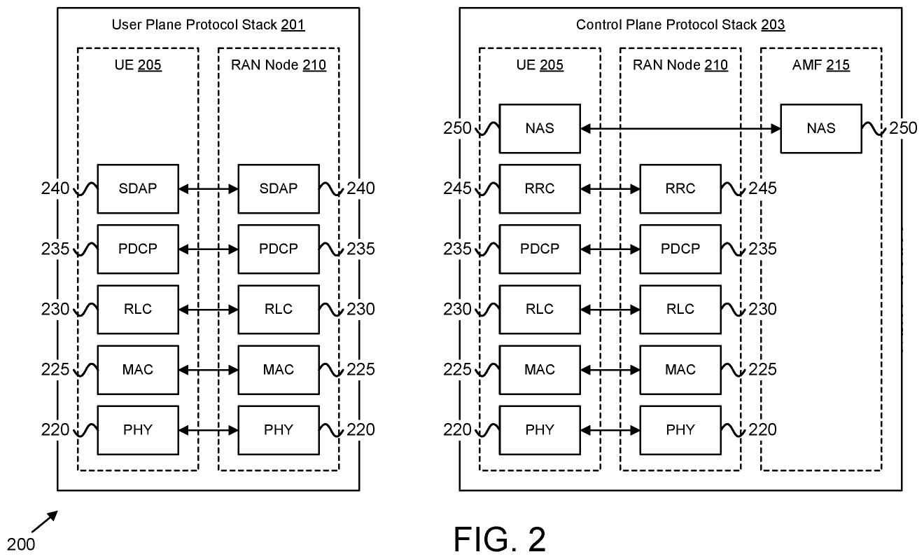

FIG. 2 depicts a NR protocol stack 200, according to embodiments of the disclosure. While FIG. 2 shows the UE 205, the RAN node 210 and an AMF 215 in a 5G core network (“5GC”), these are representative of a set of remote units 105 interacting with a base unit 121 and a mobile core network 140. As depicted, the protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a physical layer 220, a MAC sublayer 225, a RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer (also referred to as “AS protocol stack”) for the User Plane protocol stack 201 consists of at least SDAP, PDCP, RLC and MAC sublayers, and the physical layer. The AS layer for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 245 and the NAS layer 250 for the control plane and includes, e.g., an Internet Protocol (“IP”) layer and/or PDU Layer (not depicted) for the user plane. L1 and L2 are referred to as “lower layers,” while L3 and above (e.g., transport layer, application layer) are referred to as “higher layers” or “upper layers.”

The physical layer 220 offers transport channels to the MAC sublayer 225. The physical layer 220 may perform a Clear Channel Assessment and/or Listen-Before-Talk (“CCA/LBT”) procedure using energy detection thresholds, as described herein. In certain embodiments, the physical layer 220 may send a notification of UL Listen-Before-Talk (“LBT”) failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and the 5GC 215. NAS messages are passed transparently through the RAN. The NAS layer 250 is used to manage the establishment of communication sessions and for maintaining continuous communications with the UE 205 as it moves between different cells of the RAN. In contrast, the AS layer is between the UE 205 and the RAN (e.g., RAN node 210) and carries information over the wireless portion of the network.

For Rel-17, the different positioning requirements are especially stringent with respect to accuracy, latency and reliability. Table 1 shows the positioning performance requirements for different scenarios in an IIoT or indoor factory setting.

TABLE 1
IIoT Positioning Performance Requirements from TS 22.104

| | | | | | | | Latency for | | | Corresponding |
|---|---|---|---|---|---|---|---|---|---|---|
| | | | | | | | position | | | Positioning |
| | Horizontal | | Vertical | | | | estimation | | UE | Service Level |
| Scenario | accuracy | | accuracy | | Availability | Heading | of UE | | Speed | in TS 22.261 |
| Mobile control | <5 | m | <3 | m | 90% | N/A | <5 | s | N/A | Service Level 2 |
| panels with safety | | | | | | | | | | |
| functions (non- | | | | | | | | | | |
| danger zones) | | | | | | | | | | |
| Process automation - | <1 | m | <3 | m | 90% | N/A | <2 | s | <30 km/h | Service Level 3 |
| plant asset management | | | | | | | | | | |
| Flexible, modular | <1 m | | N/A | | 99% | N/A | 1 | s | <30 km/h | Service Level 3 |
| assembly area in | (relative | | | | | | | | | |
| smart factories (for | positioning) | | | | | | | | | |
| tracking of tools at | | | | | | | | | | |
| the work-place | | | | | | | | | | |
| location) | | | | | | | | | | |
| Augmented reality | <1 | m | <3 | m | 99% | <0.17 rad | <15 | ms | <10 km/h | Service Level 4 |
| in smart factories | | | | | | | | | | |
| Mobile control | <1 | m | <3 | m | 99.9% | <0.54 rad | <1 | s | N/A | Service Level 4 |
| panels with safety | | | | | | | | | | |
| functions in smart | | | | | | | | | | |
| factories (within | | | | | | | | | | |
| factory danger zones) | | | | | | | | | | |
| Flexible, modular | <50 | cm | <3 | m | 99% | N/A | 1 | s | <30 km/h | Service Level 5 |
| assembly area in | | | | | | | | | | |
| smart factories (for | | | | | | | | | | |
| autonomous vehicles, | | | | | | | | | | |
| only for monitoring | | | | | | | | | | |
| proposes) | | | | | | | | | | |
| Inbound logistics | <30 cm (if | | <3 | m | 99.9% | N/A | 10 | ms | <30 km/h | Service Level 6 |
| for manufacturing | supported | | | | | | | | | |
| (for driving | by further | | | | | | | | | |
| trajectories (if | sensors like | | | | | | | | | |
| supported by further | camera, | | | | | | | | | |
| sensors like camera, | GNSS, IMU) | | | | | | | | | |
| GNSS, IMU) of | | | | | | | | | | |
| indoor autonomous | | | | | | | | | | |
| driving systems)) | | | | | | | | | | |
| Inbound logistics | <20 | cm | <20 | cm | 99% | N/A | <1 | s | <30 km/h | Service Level 7 |

for manufacturing
(for storage of
goods)

The supported positioning techniques in Rel-16 are listed in Table 2 from TS38.305.

TABLE 1
Supported Rel-16 UE positioning methods

| | | | NG-RAN | Secure User |
|---|---|---|---|---|
| | UE- | UE-assisted, | node | Plane Location |
| Method | based | LMF-based | assisted | (“SUPL”) |
| A-GNSS | Yes | Yes | No | Yes (UE-based |
| | | | | and UE-assisted) |
| OTDOA | No | Yes | No | Yes (UE-assisted) |
| E-CID | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

Some UE positioning techniques supported in Rel-16 are listed in Table 3. The separate positioning techniques as indicated in Table 3 may be currently configured and performed based on the requirements of the location management function (“LMF”) and/or UE capabilities. Note that Table 3 includes Terrestrial Beacon System (“TBS”) positioning based on Positioning Reference Signals (“PRS”) signals, but only observed time difference of arrival (“OTDOA”) based on LTE signals is supported. The E-CID includes Cell-ID for NR method. The TBS method refers to TBS positioning based on Metropolitan Beacon System (“MBS”) signals.

Separate positioning techniques as indicated in Table 2 can be currently configured and performed based on the requirements of the LMF and UE capabilities. The transmission of PRS enable the UE to perform UE positioning-related measurements to enable the computation of a UE's location estimate and are configured per Transmission Reception Point (“TRP”), where a TRP may transmit one or more beams.

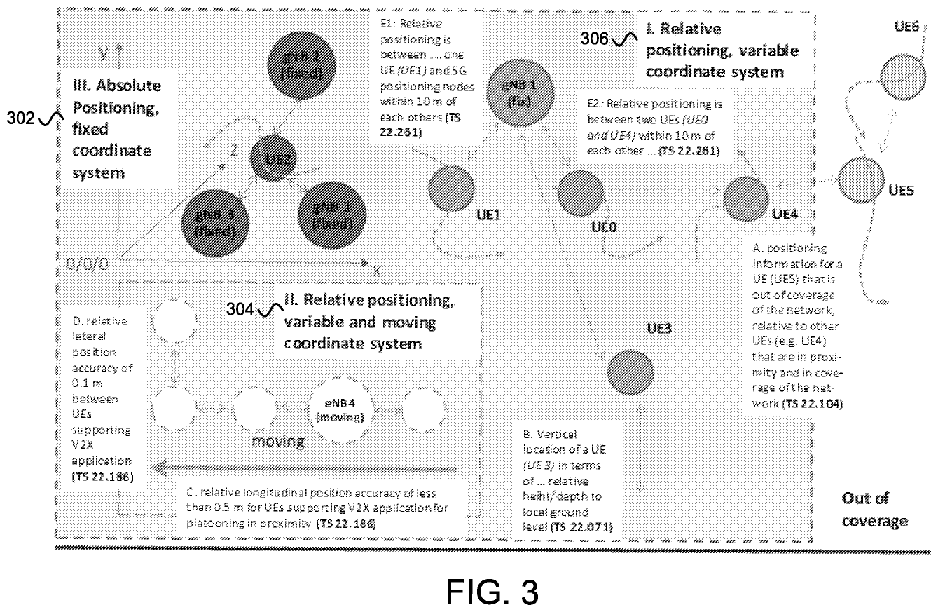

FIG. 3 depicts an overview of one embodiment of the absolute and relative positioning scenarios as defined in the architectural (stage 1) specifications using three different co-ordinate systems: Absolute Positioning, fixed coordinate systems 302; Relative Positioning, variable and moving coordinate system 304; and Relative Positioning, variable coordinate system 306.

Regarding sidelink positioning scenarios, the following scenarios are considered in the context of SL Positioning:
Scenario 1: In-coverage (Independent of LMF deployment):
   Both UE 1 (Initiator UE) and UE 2 (Rx UE) are in-coverage of gNB (both have a Uu link)
   Triggers
   Range: Determine UE1-UE2 distance/angle with response to (“wrt”) to UE1
   Relative Positioning: Determine the 2D/3D coordinate information wrt to UE1.
   UE1-UE2 have a PC5 link. (Mode 1 RA->gNB)
   Relative Positioning Calculation Entity:
      1) UE1
      2) gNB
   Same cell/different cells
Scenario 2: Partial-coverage:
   UE 1 (with Uu link) and UE 2 (only PC5 link)
   Range: Determine UE1-UE2 distance/angle wrt to UE1
   Relative Positioning: Determine the 2D/3D coordinate information wrt to UE1.
   UE1-UE2 have a PC5 link. (Mode 1 RA->gNB, LMF (UE1); Mode 2 RA (UE2))
   Relative Positioning Calculation Entity:
      1) UE1
      2) gNB
Scenario 3: Out-of-coverage
   UE 1 (only PC5 link) and UE 2 (only PC5 link)
   Range: Determine UE1-UE2 distance/angle wrt to UE1
   Relative Positioning: Determine the 2D/3D coordinate information wrt to UE1.
   UE1-UE2 have a PC5 link. (Mode 2 RA/Pre-configured (UE1, UE2))
   Relative Positioning Calculation Entity:
      1) UE1
Scenario 4: LMF-centric deployment (For Uu accuracy enhancement over LPP)
   Both UE 1 (Initiator UE) and UE 2 (Rx UE) are in-coverage/partial coverage of gNB (both have a Uu link)
   Range: Determine UE1-UE2 distance/angle wrt to UE1
   Relative Positioning: Determine the 2D/3D coordinate information wrt to UE1.
   UE1-UE2 have a PC5 link. (Mode 1 RA->gNB, LMF (UE1); Mode 2 RA (UE2))
   Absolute positioning refining Entity (using Relative positioning):
      1) UE1
      2) gNB
      3) LMF

The table below depicts synchronization reference priority levels:

DIFFERENT SETS OF PRIORITIES FOR A
SYNCHRONIZATION REFERENCE

| Priority | GNSS-based | gNB/eNB-based |
|---|---|---|
| Level | synchronization | synchronization |
| Level 1 | GNSS | gNB/eNB |
| Level 2 | SyncRef UE in network | SyncRef UE directly |
| | coverage and directly | synchronized to gNB/eNB, |
| | synchronized to GNSS, i.e., | i.e., with I_{IC} = 1 and with |
| | with I_{IC} = 1 and SLSS ID = | SLSS ID = (1, . . . , 335) |
| | (0) | |
| Level 3 | SyncRef UE out of | SyncRef UE out of |
| | GNSS/network coverage and | GNSS/network coverage and |
| | one hop away from GNSS, | one hop away from a |
| | i.e., with I_{IC} = 0 and | gNB/eNB, i.e., with I_{IC} = 0 |
| | SLSS ID = (0) | and with SLSS |
| | | ID = (1, . . . , 335) |
| Level 4 | gNB/eNB | GNSS |
| Level 5 | SyncRef UE directly | SyncRef UE directly |
| | synchronized to a gNB/eNB, | synchronized to GNSS, i.e., |
| | i.e., with I_{IC} = 1 and with | with I_{IC} = 1 and SLSS ID = |
| | SLSS ID = (1, . . . , 335) | (0) |
| Level 6 | SyncRef UE out of | SyncRef UE out of |
| | GNSS/network coverage and | GNSS/network coverage and |
| | one hop away from a gNB/eNB, | one hop away from GNSS, |
| | i.e., with I_{IC} = 0 and | i.e., with I_{IC} = 0 and |
| | SLSS ID = (1, . . . , 335) | SLSS ID = (0) |

| | |
|---|---|
| Level 7 | SyncRef UE out of GNSS/network coverage andtwo or more |
| | hops away from a gNB/eNB or GNSS, i.e., with I_{IC} = 0 and |
| | with SLSS ID = (336, 337, . . . , 671) |
| Level 8 | UE's own internal clock |

In one embodiment, the following RAT-dependent positioning techniques may be supported by the system 100:

DL-TDoA: The downlink time difference of arrival (“DL-TDOA”) positioning method makes use of the DL RS Time Difference (“RSTD”) (and optionally DL PRS RS Received Power (“RSRP”) of DL PRS RS Received Quality (“RSRQ”)) of downlink signals received from multiple TPs, at the UE (e.g., remote unit 105). The UE measures the DL RSTD (and optionally DL PRS RSRP) of the received signals using assistance data received from the positioning server, and the resulting measurements are used along with other configuration information to locate the UE in relation to the neighboring Transmission Points (“TPs”).

DL-AoD: The DL Angle of Departure (“AoD”) positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

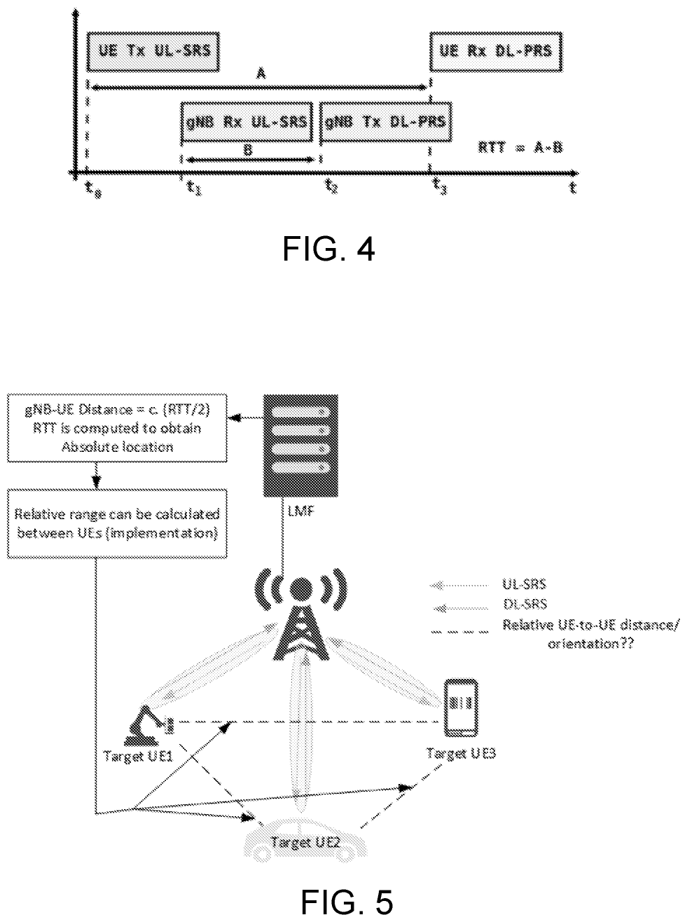

Multi-RTT: The Multiple-Round Trip Time (“Multi-RTT”) positioning method makes use of the UE Receive-Transmit (“Rx-Tx”) measurements and DL PRS RSRP of downlink signals received from multiple TRPs, measured by the UE and the gNB Rx-Tx measurements (e.g., measured by RAN node) and UL sounding reference signal (“SRS”)-RSRP at multiple TRPs of uplink signals transmitted from UE, as shown in FIG. 4.

As shown in FIG. 5, the UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the Round Trip Time (“RTT”) at the positioning server which are used to estimate the location of the UE. In one embodiment, Multi-RTT is only supported for UE-assisted/NG-RAN assisted positioning techniques, as noted in Table 3.

E-CID/NR E-CID: Enhanced Cell ID (“CID”) positioning method, the position of a UE is estimated with the knowledge of its serving ng-eNB, gNB and cell and is based on LTE signals. The information about the serving ng-eNB, gNB and cell may be obtained by paging, registration, or other methods. NR Enhanced Cell ID (“NR E-CID”) positioning refers to techniques which use additional UE measurements and/or NR radio resource and other measurements to improve the UE location estimate using NR signals.

Although NR E-CID positioning may utilize some of the same measurements as the measurement control system in the RRC protocol, the UE generally is not expected to make additional measurements for the sole purpose of positioning; e.g., the positioning procedures do not supply a measurement configuration or measurement control message, and the UE reports the measurements that it has available rather than being required to take additional measurement actions.

UL-TDoA: The UL TDOA positioning method makes use of the UL TDOA (and optionally UL SRS-RSRP) at multiple reception points (“RPs”) of uplink signals transmitted from the UE. The RPs measure the UL TDOA (and optionally UL SRS-RSRP) of the received signals using assistance data received from the positioning server, and the resulting measurements are used along with other configuration information to estimate the location of the UE.

UL-AoA: The UL Angle of Arrival (“AoA”) positioning method makes use of the measured azimuth and the zenith angles of arrival at multiple RPs of uplink signals transmitted from the UE. The RPs measure A-AoA and Z-AoA of the received signals using assistance data received from the positioning server, and the resulting measurements are used along with other configuration information to estimate the location of the UE.

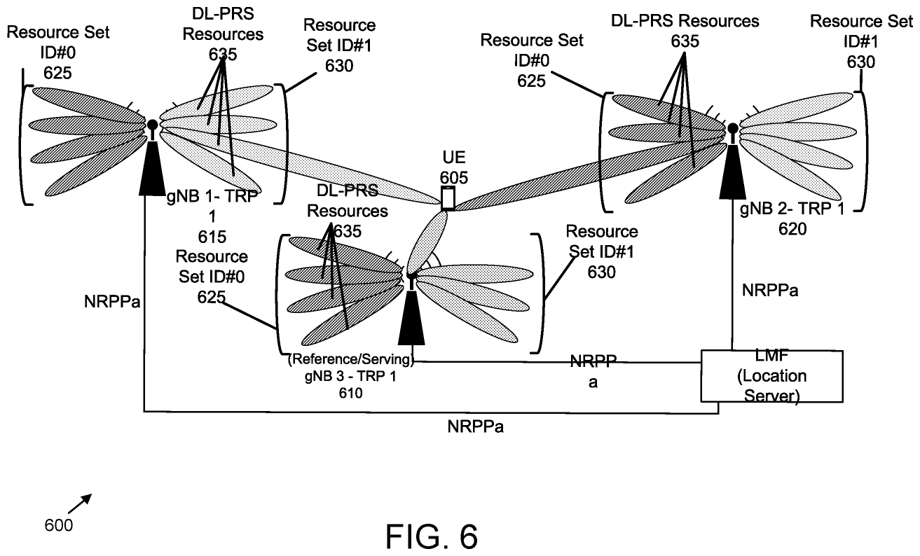

FIG. 6 depicts a system 600 for NR beam-based positioning. According to Rel-16, the PRS can be transmitted by different base stations (serving and neighboring) using narrow beams over Frequency Range #1 Between (“FR1”, e.g., frequencies from 410 MHz to 7125 MHz) and Frequency Range #2 (“FR2”, e.g., frequencies from 24.25 GHz to 52.6 GHz), which is relatively different when compared to LTE where the PRS was transmitted across the whole cell.

As illustrated in FIG. 6, a UE 605 may receive PRS from a first gNB (“gNB 3”) 610, which is a serving gNB, and also from a neighboring second gNB (“gNB 1”) 615, and a neighboring third gNB (“gNB 2”) 620. Here, the PRS can be locally associated with a set of PRS Resources grouped under a Resource Set ID for a base station (e.g., TRP). In the depicted embodiments, each gNB 610, 615, 620 is configured with a first Resource Set ID 625 and a second Resource Set ID 630. As depicted, the UE 605 receives PRS on transmission beams; here, receiving PRS from the gNB 3 610 on a set of PRS Resources 635 from the second Resource Set ID 630, receiving PRS from the gNB 1 615 on a set of PRS Resources 635 from the second Resource Set ID 630, and receiving PRS from the gNB 2 620 on a set of PRS Resources 635 from the first Resource Set ID 625.

Similarly, UE positioning measurements such as Reference Signal Time Difference (“RSTD”) and PRS RSRP measurements are made between beams as opposed to different cells as was the case in LTE. In addition, there are additional UL positioning methods for the network to exploit to compute the target UE's location. Table 4 lists the RS-to-measurements mapping required for each of the supported RAT-dependent positioning techniques at the UE, and Table 5 lists the RS-to-measurements mapping required for each of the supported RAT-dependent positioning techniques at the gNB.

TABLE 4
UE Measurements to enable RAT-dependent positioning techniques

| | | To facilitate |
|---|---|---|
| | | support of |
| | | the following |
| DL/UL Reference | | positioning |
| Signals | UE Measurements | techniques |
| Rel-16 DL PRS | DL RSTD | DL-TDOA |
| Rel-16 DL PRS | DL PRS RSRP | DL-TDOA, |
| | | DL-AoD, |
| | | Multi-RTT |
| Rel-16 DL PRS/Rel-16 | UE Rx-Tx time difference | Multi-RTT |
| SRS for positioning | | |
| Rel. 15 SSB/CSI-RS for | SS-RSRP(RSRP for RRM), | E-CID |
| RRM | SS-RSRQ(for | |
| | RRM), CSI-RSRP | |
| | (for RRM), CSI-RSRQ | |
| | (for RRM), SS-RSRPB (for RRM) | |

### Measurement and Report Configuration

TABLE 5
gNB Measurements to enable RAT-dependent positioning techniques

| | | To facilitate support |
|---|---|---|
| | | of the following |
| DL/UL Reference Signals | gNB Measurements | positioning techniques |
| Rel-16 SRS for positioning | UL RTOA | UL-TDOA |
| Rel-16 SRS for positioning | UL SRS-RSRP | UL-TDOA, UL-AoA, |
| | | Multi-RTT |
| Rel-16 SRS for positioning, | gNB Rx-Tx | Multi-RTT |
| Rel-16 DL PRS | time difference | |
| Rel-16 SRS for positioning, | A-AoA and Z-AoA | UL-AoA, Multi-RTT |

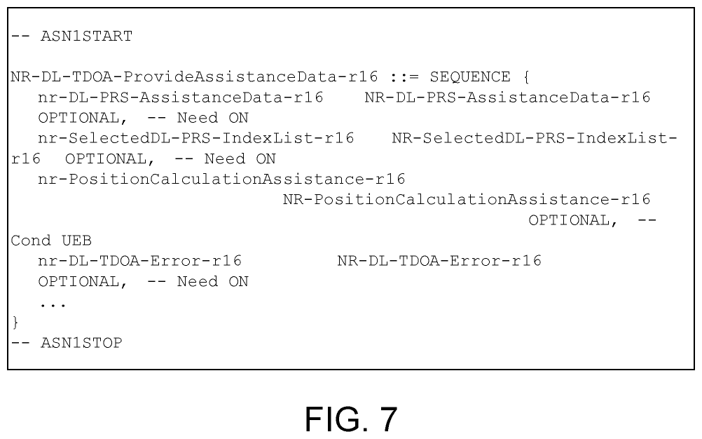

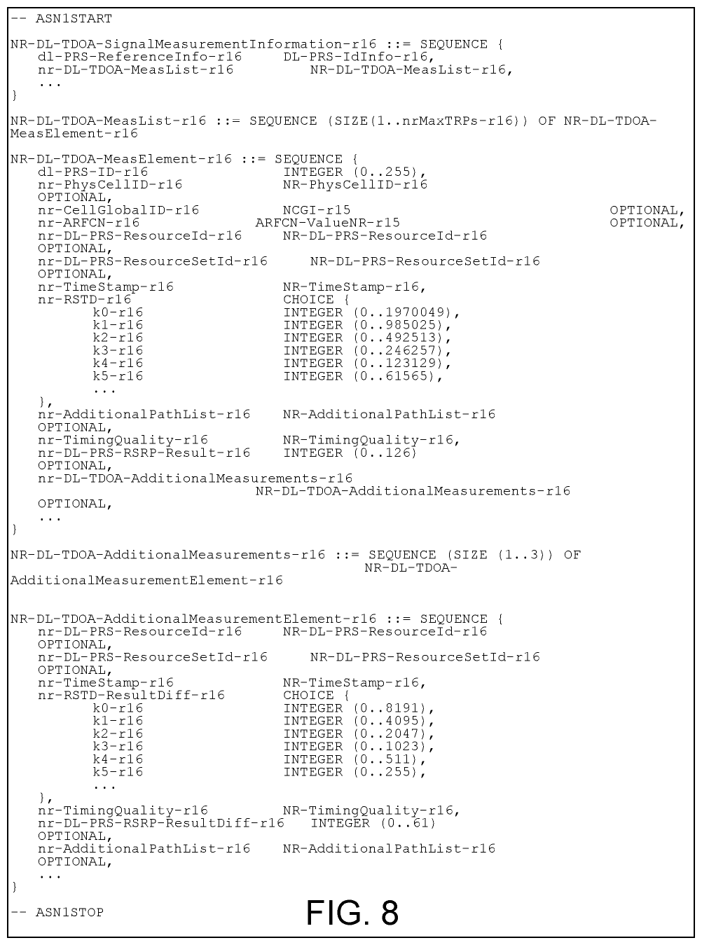

According to TS38.215, UE measurements have been defined, which are applicable to DL-based positioning techniques, see subclause 2.4. For a conceptual overview of the current implementation in Rel-16, the DL-TDOA assistance data configurations (see FIG. 7) and measurement reporting information (see FIG. 8) are provided as illustrative examples.

Regarding RAT-dependent Positioning Measurements, the different DL measurements including DL PRS-RSRP, DL RSTD and UE Rx-Tx Time Difference required for the supported RAT-dependent positioning techniques are shown in Table 5. The following measurement configurations are specified, e.g., in TS38.215:
4 Pair of DL RSTD measurements can be performed per pair of cells. Each measurement is performed between a different pair of DL PRS Resources/Resource Sets with a single reference timing.
8 DL PRS RSRP measurements can be performed on different DL PRS resources from the same cell.

TABLE 5
DL Measurements required for DL-based positioning methods,
e.g., from TS38.215
DL PRS reference signal received power (DL PRS-RSRP)

| | |
|---|---|
| Definition | DL PRS reference signal received power |
| | (DL PRS-RSRP), is defined as the linear |
| | average over the power contributions (in |
| | [W]) of the resource elements that carry DL |
| | PRS reference signals configured for RSRP |
| | measurements within the considered |
| | measurement frequency bandwidth. |
| | For frequency range 1, the reference point |
| | for the DL PRS-RSRP shall be the antenna |
| | connector of the UE. For frequency range 2, |
| | DL PRS-RSRP shall be measured based |
| | on the combined signal from antenna |
| | elements corresponding to a given receiver |
| | branch. For frequency range 1 and 2, if |
| | receiver diversity is in use by the UE, the |
| | reported DL PRS-RSRP value shall not be |
| | lower than the corresponding DL PRS- |
| | RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL |
| | RSTD) is the DL relative timing difference |
| | between the positioning node j and the |
| | reference positioning node i, defined as |
| | T_{SubframeRxj} − T_{SubframeRxi}, |
| | Where: |
| | T_{SubframeRxj} is the time when the UE receives |
| | the start of one subframe from positioning |
| | node j. |
| | T_{SubframeRxi} is the time when the UE receives |
| | the corresponding start of one subframe |
| | from positioning node i that is closest in |
| | time to the subframe received from |
| | positioning node j. |
| | Multiple DL PRS resources can be used to |
| | determine the start of one subframe from a |
| | positioning node. |
| | For frequency range 1, the reference point |
| | for the DL RSTD shall be the antenna |
| | connector of the UE. For frequency range 2, |
| | the reference point for the DL RSTD shall |
| | be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is |
| | defined as T_{UE-RX} − T_{UE-TX} |
| | Where: |
| | T_{UE-RX} is the UE received timing of |
| | downlink subframe #i from a positioning node, |
| | defined by the first detected path in time. |
| | T_{UE-TX} is the UE transmit timing of uplink |
| | subframe #j that is closest in time to the |
| | subframe #i received from the positioning node. |
| | Multiple DL PRS resources can be used to |
| | determine the start of one subframe of the |
| | first arrival path of the positioning node. |
| | For frequency range 1, the reference point |
| | for T_{UE-RX} measurement shall be the Rx |
| | antenna connector of the UE and the reference |
| | point for T_{UE-TX} measurement shall be |
| | the Tx antenna connector of the UE. For |
| | frequency range 2, the reference point for |
| | T_{UE-RX} measurement shall be the Rx antenna |
| | of the UE and the reference point for |
| | T_{UE-TX} measurement shall be the Tx antenna of the UE. |
| Applicable for | RRC_CONNECTED intra-frequency |
| | RRC_CONNECTED inter-frequency |

In one embodiment, Integrity and Reliability of the positioning estimate is defined by the following parameters:
Alert limit (“AL”): The maximum allowable positioning error such that the positioning system is available for the intended application. If the positioning error is beyond the AL, operations are hazardous and the positioning system should be declared unavailable for the intended application to prevent loss of integrity.
NOTE: When the AL bounds the positioning error in the horizontal plane or on the vertical axis then it is called Horizontal Alert Limit (“HAL”) or Vertical Alert Limit (“VA” L) respectively.
Target Integrity Risk (“TIR”): The probability that the positioning error exceeds the Alert Limit (“AL”) without warning the user within the required Time-to-Alert (“TTA”).
NOTE: The TIR is usually defined as a probability rate per some time unit (e.g. per hour, per second or per independent sample).
Time to alert: The maximum allowable elapsed time from when the positioning error exceeds the AL until the function providing position integrity annunciates a corresponding alert.

This present disclosure solves the less accurate relative positioning/ranging due to NLOS/multipath with solution for enabling SL cooperative positioning based on information provided from reference UEs to target UEs, whose positioning is to be determined. The relative positioning between two UEs, when requested to be measured transmits SL PRS and after it determines the NLOS between them it could use information from other UEs nominated as reference UEs. In this solution, these reference UEs may transmit SL PRS towards the target UEs whose relative positioning is to be determined and uses Haversine Formula to determine the final estimated relative positioning between target UEs. In some examples, a reference UE with known location or location that can be determined, e.g., in coverage UE with location determined by RAT-dependent positioning techniques, UE with GNSS capability and coverage.

The solution aims to exploit both Uu and PC5 interfaces and solutions in this disclosure cover at least three different SL coverage scenarios mainly; scenario 2 (partial coverage), scenario 3 (out of coverage) and scenario 4 (LMF-centric deployment) as noted above.

In one embodiment, the solution enables the determination of relative position of blind (blocked) UEs using information from reference UE(s) (e.g., anchor UE(s)) using sidelink. Besides, the method can use information from more than one reference UEs (e.g., anchor UEs) to enhance the relative positioning accuracy. In some examples, the absolute position of the UEs may be determined based on the absolute position of the reference UE(s) and the relative positioning measurements. The solution also details the procedure of choosing reference UEs based on a priority level metric.

In one embodiment, the proposed solution provides cooperative positioning to enable UEs that cannot use conventional UL/DL positioning methods and blind/blocked UEs to get their relative location, when requested/initiated. In one embodiment, another advantage is exploiting information redundancy provided by more than one reference UEs to enhance the positioning accuracy.

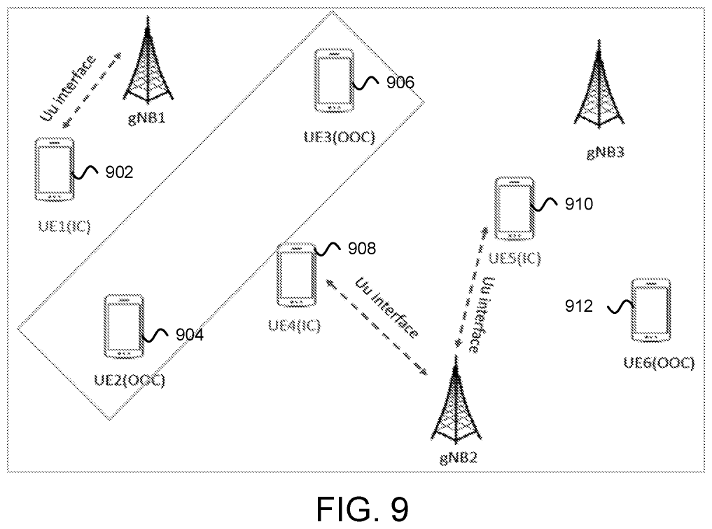

According to a first embodiment, the network setup may be as shown in FIG. 9, where UE1 902, UE4 904 and UE5 910 communicate with the network over 5G NR air interface (via the Uu links), whereas UE2 904, UE3 906, and U6 912 are out of coverage (No Uu link). In this case, UEs having Uu link (UE1 902, UE4 904 and UE5 910) have requested their location apriori using one of the conventional (e.g., RAT-dependent) UL/DL positioning methods, e.g., timing-based methods such as UL-TDOA, DL-RTOA, multi-RTT or angle-based methods such as UL-AoA and DL-AoD by sending UL positioning SRS to gNB or receiving and measuring DL PRS from gNB(s). Since UE2 904, UE3 906, and UE6 912 are out of coverage UEs, it may be assumed that they may or may not had acquired their absolute positions using other positioning technologies, e.g. RAT-independent technologies as GNSS. UE2 is the initiator UE and the UE3 906 is the target/responder UE of the ranging/relative positioning session.

In one embodiment, UE2 904 has acquired its absolute position based on other positioning technologies and indicates its absolute position to UE3 906; UE3 906 determines the ranging/relative positioning based on the received UE2 904 absolute position e.g., based on received UE2 904 absolute position and UE3 906 absolute position. In some examples, UE2 904 may request UE3 906 to report its absolute position, and the UE2 904 may determine the ranging/relative positioning based on the received UE3 906 absolute position.

In the first embodiment, the SL multipath/NLOS detection procedures are described prior to initiating a SL cooperative positioning session. UE2 904 may initiate UE2-UE3 ranging calculation. The ranging calculation may comprise a distance, orientation, angle calculation of UE3 906 relative to UE2 904. In this case, UE2 904 may initially transmit a SL positioning request to perform SL positioning with UE3 906 and receive an appropriate positive or negative acknowledgement to participate in the SL positioning session with UE2 904. The UE2 904 may transmit a discovery request using a default L2 id where the L2 id could be that of the default positioning id and UE3 906 after receiving the discovery request responds with the discovery response to initiate the sidelink positioning session between them. Thereafter, UE2 904 transmits a (pre-)configured SL PRS to UE3 906 requesting UE3 906 to perform SL RAT-dependent measurements to determine its relative position with respect to UE3 906 and report the associated information, e.g., measurement reports, quality of measurements to UE2 904. The configured SL PRS may be also based on an out-of-coverage (pre)configuration or prior configuration based on UE2's last visited cell/SIB.

In one embodiment, UE3 906 may not accurately receive SL PRS transmitted by UE2 904 due to either multipath effects arising from scatters or reflections in the radio environment or when the link between UEs is blocked (i.e., NLOS or low SNR/SINR or an unreliable and poor link). Otherwise the UE3 906 detects from the received SL PRS about the NLOS/multipath detection based on the arrival of paths. For LOS/NLOS detection itself, a few methods can be considered at high level. First, there exist PHY layer signal processing algorithms for LOS detections relying on hypothesis testing, Bayesian inference or machine learning techniques. For example, a UE can estimate Channel Impulse Response (“CIR”) and declare if a channel link is LOS channel profile or NLOS channel profile. Criteria of channel profile evaluation will be a modem implementation issue. In some examples, a LOS/NLOS detection (e.g., probability of NLOS or LOS) may be based on the relative power of the strongest ray/path to the power of at least one other paths (e.g., 2^{nd} strongest path, sum of the power of the other paths) of the channel estimate/CIR or channel power delay profile. In some examples, a multipath detection may be based on the number of paths determined for the channel estimate/CIR or channel power delay profile.

In this case, UE3 906 cannot perform accurate or good quality measurements and detects that the PC5 link with UE2 904 is unreliable/blocked and reports NLOS/multipath detection metric to UE2 904 (initiator UE performing relative positioning or ranging). Such reporting metrics signaled from UE3 906 may include multipath information, LOS/NLOS information or combination thereof. In such implementations, the reported SL positioning measurement can be associated with a SL indicator, indicating that the probability of NLOS or LOS or combination thereof. In another exemplary implementation, the SL indicator may be a binary field. In another implementation, the confidence value associated with the receiver detection performance could be set to the lowest value indicating that the UE3 906 detects NLOS/multipath. In another implementation of this embodiment, UE2 904 may have already deemed the link to be NLOS based on previous SL radio resource management (“RRM”) measurements, e.g., SL-channel state information (“CSI”) reference signal received power (“RSRP”). These RRM measurement can be based on a previously established SL unicast/groupcast session with UE3 906.

In an alternate embodiment, the UE3 906 may report N additional paths based on SL timing, angle and power information to UE2 904. The number of N additional paths to be reported to UE2 904 may be fixed in the specification and may be relative to the first arrival path. In an example of such an implementation, N additional paths to be reported may be comprise of a power delay profile, angle delay profile or combination thereof. Based on such a SL multipath report, UE2 904 may also determine the overall link quality to initiate a cooperative session.

Furthermore, the concept can be extended to the groupcast scenario where UE2 904 may perform simultaneous LOS/NLOS detection and/or receive multiple multipath reports from a set of UEs associated within a group, e.g., UEs, within a groupcast communication scenario.

In a second embodiment directed to Cooperative Positioning to mitigate NLOS/multipath, the procedures for performing SL cooperative positioning with the aid of reference devices/UEs are described.

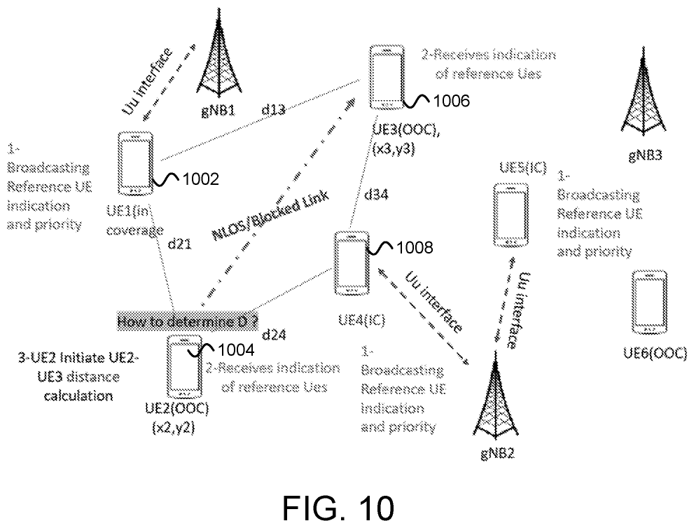

For reference UEs, in one embodiment, UE1 902, UE4 908, and UE5 910 have acquired their absolute positions (e.g., latitude and longitude) using RAT-dependent positioning methods and are nominated by gNB as reference UEs or have nominated themselves as Ref_UEs (anchor UEs for sidelink), via explicit or implicit configuration. The nomination procedure could contain additional information whether the UE nominates as reference UE for Uu positioning, SL positioning, both Uu and SL positioning. It also depends on the support of the sidelink communication by the reference UE. UE1 902, UE4 908, and UE5 910 may broadcast a parameter source Ref_ID, along with available absolute/relative positioning information in the SL control channel (e.g. SCI), SL data channel or using higher layer signaling, e.g., MAC CE, PC5 RRC, PC5-S, or via the V2X/ProSe Application layer or using the discovery request as explained in one of the scenarios shown in FIG. 10 to neighboring UEs to indicate that they are nominated as reference UEs and signal the corresponding reference UE ID (Ref_ID). The source Ref_ID may also implicitly indicate to the other UEs, its own ability to act as a reference device/UE. In an alternative implementation, explicit reference device/UE can be indicated via a separate field in the broadcast message.

In a further implementation, reference UE, UE2 1004 (initiator UE), and UE3 1006 (responder UE) may also share information via a field in a message regarding its coverage status, e.g., in-coverage or out-of-coverage scenario. In another implementation, the reference UE may also share the Ref_ID and absolute/relative positioning information via groupcast or unicast SL communications.

In one embodiment, the Initiator UE starts cooperative positioning request after NLOS/multipath detection from the responder UE. In such an embodiment, UE2 1002 (initiator UE) as explained in the first embodiment after detecting NLOS/multipath detection (or generally, high likelihood of not meeting SL positioning accuracy) starts a cooperative positioning session and transmits a CP_request (cooperative positioning request) to one of its reference UEs using the Ref_ID parameter. The cooperative positioning request could be further transmitted in-response to the NLOS/multipath detection at the responder UE, initiator UE may not fulfill the accuracy needed as per the QoS requirements for that service. Such a cooperative positioning request may be transmitted using the discovery response message or as part of the discovery request message depending on the type of the discovery model, e.g., Discovery Model A or Model B as defined in TS23.303, incorporated herein by reference.

While upon initiating the cooperative session, in one embodiment, one of the reference UEs between UE2 1004 and UE3 1006 (in our case either UE1 1002 or UE4 1008 as seen in FIG. 10) that have received the CP_request can perform the distance d_{U2_U3} computation as shown in FIG. 10, thereby calculating relative positions/ranging information between UE2 1004 and UE3 1006, which includes the timing, angular information in 3D plane. The relative position may include the range/distance between the UEs as well as the relative orientation of one UE with respect to another UE, e.g., determine UE3's 1006 orientation with respect to UE2 1004.

In one example, the reference UE might use the Haversine formula to determine the relative position between UE3 1006 and UE2 1004 and report the result to initiator UE2 1004. An uncertainty value μ_{d} can be assigned to each calculated distance d_{U2_U3} and transmitted to initiator UE2 1004. In other implementations, the UE may also compute the relative positioning using one of the following methods:
Spherical Law of Cosines
Equirectangular approximations

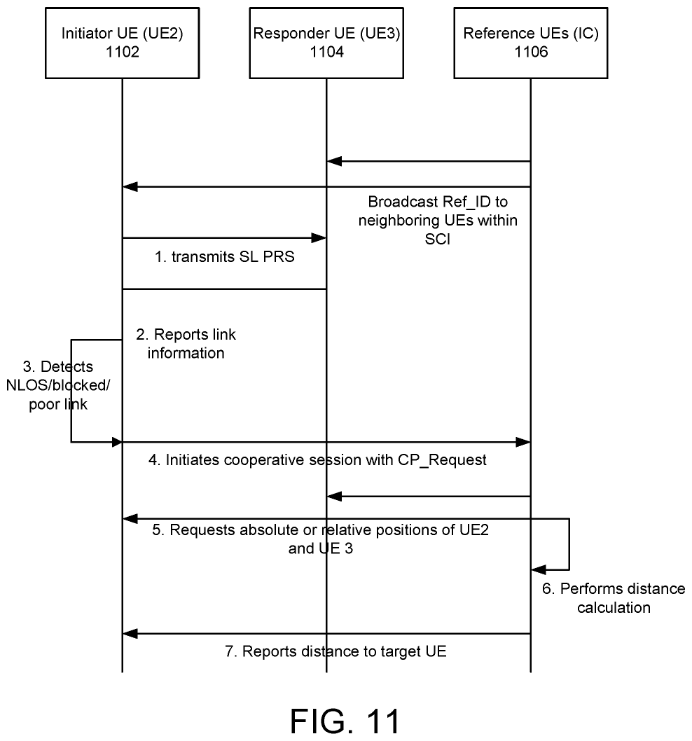

The procedure of this embodiment can be described in the following steps and also using the signaling chart shown in FIG. 11:

At step 1, in one embodiment, after Ref_ID has been broadcast UE2, initiator UE 1102 requests relative position d_{U2_U3} using SL positioning request/response signaling with UE3, responder UE 1104, thereby transmitting SL PRS towards UE3.

At steps 2 and 3, in one embodiment, UE2 1102 detects, based on UE3's 1104 measurement report about the NLOS/multipath detection, that UE2 1102, initiator UE, cannot meet the target QoS requirement in terms of the relative positioning accuracy.

At step 4, in one embodiment, UE2 1102 initiates a cooperative session by transmitting a unicast or groupcast or broadcast CP_request to neighboring reference UEs 1106 (e.g., UE1 and UE4).

At step 5, in one embodiment, the cooperation session is started at reference UEs (UE1 and UE4) 1106 by transmitting SL PRS towards UE2 1102 and UE3 1104 to calculate the distances, d₁₃, d₂₁, d₃₄, d₂₄ as part of the relative positioning information as shown in FIG. 10. Additionally, the relative orientations of UE1 and UE4 (reference UEs 1106) with respect to UE2 1102 and UE3 1104 may also be determined.

At step 6, in one embodiment, UE1 and UE4 (reference UEs 1106) receive the absolute or relative position information of UE3 1104 and perform a distance calculation to determine d_{U2_U3} (based on absolute and/or relative position information) with an associated uncertainty value d at each node.

At step 7, in one embodiment, d_{U2_U3} and associated d are transmitted from UE1 and UE4 (reference UEs 1106) to UE2 1102, the initiator UE.

The cooperative positioning can be initiated with two or more reference UEs. Upon receiving a groupcast/broadcast CP group request, reference UEs can perform the distance calculation (in our case UE1 and UE4), the resulting distances at each reference UE with the assigned uncertainty values can be averaged at initiator UE2 to further enhance the absolute/relative positioning accuracy. In another implementation, target UE might choose to average only over distances corresponding to smallest uncertainty values.

In a gNB/LMF centric approach, in one embodiment, UE2 might have a 5G NR air interface connection with gNB and UE3 is out of coverage. In one implementation, UE2 might request the distance d_{U2_U3} calculation by transmitting SL PRS to UE3. In this case, it detects that the link with UE3 is blocked/NLOS/multipath detection as described above. It then starts a cooperative positioning session by transmitting a unicast or groupcast or broadcast CP_request to its reference UEs. Reference UEs cooperate as described above to determine their absolute/relative position. Upon receiving information from reference UEs, UE2 transmits assistance data to location measurement unit (“LMU”) or location management component (“LMC”) entity at gNB if the gNB has LMF functionality (e.g., LMU or LMC capabilities) or is co-located with an LMF and requests the distance determination.

In an embodiment directed to out of coverage reference UE determination, in another network setup where all UEs are out-of-coverage, assume that UE1, UE4 and UE5 have acquired their absolute positions using RAT-independent localization methods. In this case, UE1, UE4 and UE5 nominate themselves as reference UEs if their absolute positions did not change until the expiry of a timer T_{ref}. In an alternative implementation, the reference device/UE ability to act as a reference device capability can be pre-configured. The same procedure for initiating cooperative session and determining the distance between UE2 and UE3, as described above, applies to this scenario.

In an LMF Centric Approach, according to the embodiment above and considering UE2 and UE3 are in an LMF-centric coverage scenario, where UE2 is under network coverage of an LMF while UE3 is out of coverage, the LMF may request UE2 to perform measurements in order to determine the absolute/relative positioning information with respect to UE3 (including distance d_{U2_U3}) via LTE positioning protocol (“LPP”). In this case, UE2 transmits SL PRS to UE3. And consequently, detects that the link with UE3 is blocked/NLOS/multipath detection. It then starts a cooperative positioning session by transmitting a unicast or groupcast CP_request to its reference UEs. Reference UEs cooperate as described in embodiment 1 and 2 to determine the relative/absolute position of UE3 and relay it to LMF.

In one embodiment directed to the reference UEs' priority levels, when an initiator UE (e.g., UE2) receives multiple Ref_ID parameters from different reference UEs, it performs a selection procedure in order to prioritize reference UE selection. This decision can be based on priority levels Prio_level assigned to each reference UE. In one implementation of this embodiment, if reference UEs are same as syncRef UEs, we can keep the same priority levels as defined for SyncRef UEs as shown in the table above.

In one implementation of this embodiment, priority levels can be assigned to reference UEs (which are not SyncRef UEs), based on gNB and GNSS coverage as detailed in the table below:
Highest priority levels: Ref Ues with gNB and GNSS coverage
Lowest priority level: out of GNSS and network coverage Ref UEs

Reference UEs that have both gNB and GNSS coverage, might benefit from network to better enhance accuracy of distance estimation. In this case, reference UEs might receive assistance data to mitigate positioning errors.

In an alternate implementation of this embodiment, the decision on reference UEs priority might be based on channel condition estimation between reference UE and initiator UE. Reference UEs with LOS and good link to target UEs may have the highest priority.

In another implementation of this embodiment, target UE (e.g., UE3) receives Ref_ID parameter from a first set of at least one reference UE and determines the priority and/or channel condition between the reference UE and target UE. The target UE may indicate to the initiator UE (e.g., UE2) at least one preferred reference UE (e.g., LOS and SINR/RSRP above a threshold) from the first set of reference UE(s) e.g., based on the determined priority and/or channel condition. The at least one preferred reference UE may be indicated in the measurement report to initiator UE. The initiator UE receives Ref_ID parameter from a second set of at least one reference UE. The initiator UE determines at least one reference UE for cooperative positioning based on the received at least one preferred reference UE and the second set of reference UE(s).

TABLE 6
Priority levels

| Priority | |
|---|---|
| Levels: | GNSS/gNB coverage: |
| 1 | Both GNSS + gNB coverage |
| 2 | Only GNSS coverage |
| 3 | Only gNB coverage |
| 4 | Out of GNSS and gNB coverage |

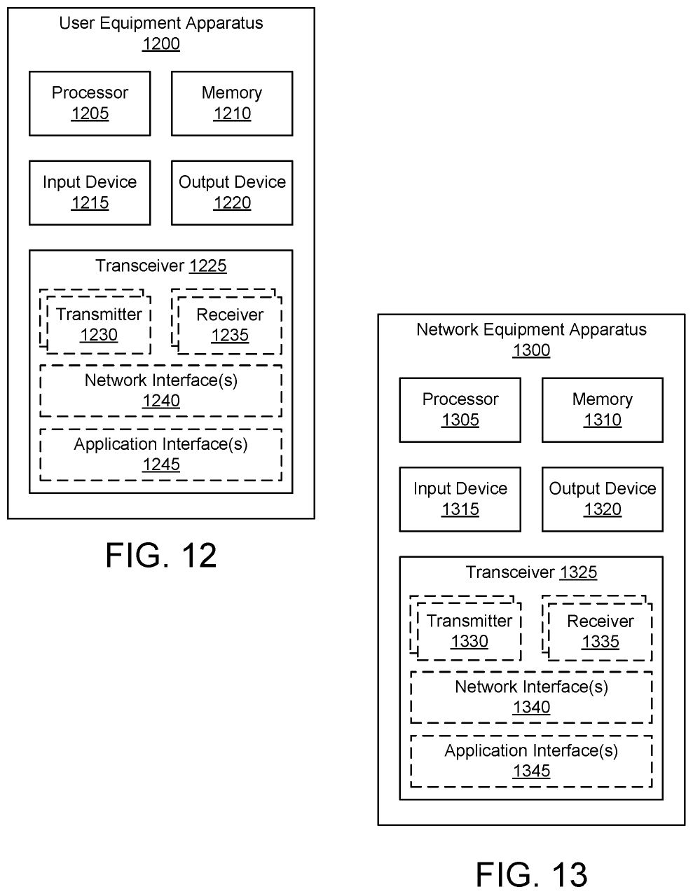

FIG. 12 depicts a user equipment apparatus 1200 that may e used for SL cooperative positioning in NLOS scenario, according to embodiments of the disclosure. In various embodiments, the user equipment apparatus 1200 is used to implement one or more of the solutions described above. The user equipment apparatus 1200 may be one embodiment of a UE, such as the remote unit 105 and/or the UE 205, as described above. Furthermore, the user equipment apparatus 1200 may include a processor 1205, a memory 1210, an input device 1215, an output device 1220, and a transceiver 1225. In some embodiments, the input device 1215 and the output device 1220 are combined into a single device, such as a touchscreen. In certain embodiments, the user equipment apparatus 1200 may not include any input device 1215 and/or output device 1220. In various embodiments, the user equipment apparatus 1200 may include one or more of: the processor 1205, the memory 1210, and the transceiver 1225, and may not include the input device 1215 and/or the output device 1220.

As depicted, the transceiver 1225 includes at least one transmitter 1230 and at least one receiver 1235. Here, the transceiver 1225 communicates with one or more base units 121. Additionally, the transceiver 1225 may support at least one network interface 1240 and/or application interface 1245. The application interface(s) 1245 may support one or more APIs. The network interface(s) 1240 may support 3GPP reference points, such as Uu and PC5. Other network interfaces 1240 may be supported, as understood by one of ordinary skill in the art.

The processor 1205, in one embodiment, may include any known controller capable of executing computer-readable instructions and/or capable of performing logical operations. For example, the processor 1205 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 1205 executes instructions stored in the memory 1210 to perform the methods and routines described herein. The processor 1205 is communicatively coupled to the memory 1210, the input device 1215, the output device 1220, and the transceiver 1225. In certain embodiments, the processor 1205 may include an application processor (also known as “main processor”) which manages application-domain and operating system (“OS”) functions and a baseband processor (also known as “baseband radio processor”) which manages radio functions.

The memory 1210, in one embodiment, is a computer readable storage medium. In some embodiments, the memory 1210 includes volatile computer storage media. For example, the memory 1210 may include a RAM, including dynamic RAM (“DRAM”), synchronous dynamic RAM (“SDRAM”), and/or static RAM (“SRAM”). In some embodiments, the memory 1210 includes non-volatile computer storage media. For example, the memory 1210 may include a hard disk drive, a flash memory, or any other suitable non-volatile computer storage device. In some embodiments, the memory 1210 includes both volatile and non-volatile computer storage media.

In some embodiments, the memory 1210 stores data related to supporting SL cooperative positioning in NLOS scenario. For example, the memory 1210 may store parameters, configurations, resource assignments, policies, and the like as described above. In certain embodiments, the memory 1210 also stores program code and related data, such as an operating system or other controller algorithms operating on the user equipment apparatus 1200, and one or more software applications.

The input device 1215, in one embodiment, may include any known computer input device including a touch panel, a button, a keyboard, a stylus, a microphone, or the like. In some embodiments, the input device 1215 may be integrated with the output device 1220, for example, as a touchscreen or similar touch-sensitive display. In some embodiments, the input device 1215 includes a touchscreen such that text may be input using a virtual keyboard displayed on the touchscreen and/or by handwriting on the touchscreen. In some embodiments, the input device 1215 includes two or more different devices, such as a keyboard and a touch panel.

The output device 1220, in one embodiment, is designed to output visual, audible, and/or haptic signals. In some embodiments, the output device 1220 includes an electronically controllable display or display device capable of outputting visual data to a user. For example, the output device 1220 may include, but is not limited to, an LCD display, an LED display, an OLED display, a projector, or similar display device capable of outputting images, text, or the like to a user. As another, non-limiting, example, the output device 1220 may include a wearable display separate from, but communicatively coupled to, the rest of the user equipment apparatus 1200, such as a smart watch, smart glasses, a heads-up display, or the like. Further, the output device 1220 may be a component of a smart phone, a personal digital assistant, a television, a table computer, a notebook (laptop) computer, a personal computer, a vehicle dashboard, or the like.

In certain embodiments, the output device 1220 includes one or more speakers for producing sound. For example, the output device 1220 may produce an audible alert or notification (e.g., a beep or chime). In some embodiments, the output device 1220 includes one or more haptic devices for producing vibrations, motion, or other haptic feedback. In some embodiments, all or portions of the output device 1220 may be integrated with the input device 1215. For example, the input device 1215 and output device 1220 may form a touchscreen or similar touch-sensitive display. In other embodiments, the output device 1220 may be located near the input device 1215.

The transceiver 1225 includes at least transmitter 1230 and at least one receiver 1235. The transceiver 1225 may be used to provide UL communication signals to a base unit 121 and to receive DL communication signals from the base unit 121, as described herein. Similarly, the transceiver 1225 may be used to transmit and receive SL signals (e.g., V2X communication), as described herein. Although only one transmitter 1230 and one receiver 1235 are illustrated, the user equipment apparatus 1200 may have any suitable number of transmitters 1230 and receivers 1235. Further, the transmitter(s) 1230 and the receiver(s) 1235 may be any suitable type of transmitters and receivers. In one embodiment, the transceiver 1225 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1225, transmitters 1230, and receivers 1235 may be implemented as physically separate components that access a shared hardware resource and/or software resource, such as for example, the network interface 1240.

In various embodiments, one or more transmitters 1230 and/or one or more receivers 1235 may be implemented and/or integrated into a single hardware component, such as a multi-transceiver chip, a system-on-a-chip, an ASIC, or other type of hardware component. In certain embodiments, one or more transmitters 1230 and/or one or more receivers 1235 may be implemented and/or integrated into a multi-chip module. In some embodiments, other components such as the network interface 1240 or other hardware components/circuits may be integrated with any number of transmitters 1230 and/or receivers 1235 into a single chip. In such embodiment, the transmitters 1230 and receivers 1235 may be logically configured as a transceiver 1225 that uses one more common control signals or as modular transmitters 1230 and receivers 1235 implemented in the same hardware chip or in a multi-chip module.

In one embodiment, the processor 1205 is configured to transmit a cooperative positioning request message to at least one reference device comprising a ranging or relative positioning request between the apparatus and a target device. In one embodiment, the processor 1205 is configured to receive at least one positioning quantity from the at least one reference device. In one embodiment, the processor 1205 is configured to determine ranging or relative position between the at least one reference device and the target device based on the received at least one positioning quantity.

In one embodiment, the processor 1205 is configured to transmit the cooperative positioning request message in response to determining a positioning quality metric between the apparatus and the target device is below a threshold.

In one embodiment, the positioning quality metric comprises at least one of LOS/non-LOS metric and a multipath detection metric.

In one embodiment, the processor 1205 is configured to receive SL positioning reference signals from the at least one reference device and transmit a positioning measurement report to the at least one reference device for determining at least a portion of the at least one positioning quantity.

In one embodiment, the ranging or relative positioning comprises distance and/or orientation between the apparatus and the target device.

In one embodiment, the at least one positioning quantity comprises an absolute position or a relative position of at least one of the apparatus or the target device.

In one embodiment, the at least one positioning quantity comprises a quantity based on RAT-dependent positioning techniques, RAT-independent positioning techniques or combination thereof.

In one embodiment, the processor 1205 is configured to receive information comprising at least Ref_ID parameter from a set of reference devices and determine the at least one reference device from the set of reference devices based on at least one of a priority level metric, a location of the at least one reference device, a channel condition between the apparatus and the at least one reference device.

In one embodiment, the processor 1205 is configured to receive at least one preferred reference device from the target device and determine the at least one reference device based on the received at least one preferred reference device.

In one embodiment, the processor 1205 is configured to transmit SL positioning reference signals to the target device and receive a positioning measurement report comprising the positioning quality metric from the target device.

In one embodiment, the processor 1205 is configured to receive a cooperative positioning request message from a network device comprising a ranging or relative positioning request between the network device and a target device. In one embodiment, the processor 1305 is configured to transmit at least one positioning quantity to the network device for determining ranging or relative position between the at least one reference device and the target device based on the received at least one positioning quantity.

FIG. 13 depicts one embodiment of a network apparatus 1300 that may be used for SL cooperative positioning in NLOS scenario, according to embodiments of the disclosure. In some embodiments, the network apparatus 1300 may be one embodiment of a RAN node and its supporting hardware, such as the base unit 121 and/or gNB, described above. Furthermore, network apparatus 1300 may include a processor 1305, a memory 1310, an input device 1315, an output device 1320, and a transceiver 1325. In certain embodiments, the network apparatus 1300 does not include any input device 1315 and/or output device 1320.

As depicted, the transceiver 1325 includes at least one transmitter 1330 and at least one receiver 1335. Here, the transceiver 1325 communicates with one or more remote units 105. Additionally, the transceiver 1325 may support at least one network interface 1340 and/or application interface 1345. The application interface(s) 1345 may support one or more APIs. The network interface(s) 1340 may support 3GPP reference points, such as Uu, N1, N2, N3, N5, N6 and/or N7 interfaces. Other network interfaces 1340 may be supported, as understood by one of ordinary skill in the art.

The processor 1305, in one embodiment, may include any known controller capable of executing computer-readable instructions and/or capable of performing logical operations. For example, the processor 1305 may be a microcontroller, a microprocessor, a CPU, a GPU, an auxiliary processing unit, an FPGA, a DSP, a co-processor, an application-specific processor, or similar programmable controller. In some embodiments, the processor 1305 executes instructions stored in the memory 1310 to perform the methods and routines described herein. The processor 1305 is communicatively coupled to the memory 1310, the input device 1315, the output device 1320, and the transceiver 1325. In certain embodiments, the processor 1305 may include an application processor (also known as “main processor”) which manages application-domain and OS functions and a baseband processor (also known as “baseband radio processor”) which manages radio function. In various embodiments, the processor 1305 controls the network apparatus 1300 to implement the above described network entity behaviors (e.g., of the gNB) for SL cooperative positioning in NLOS scenario.

The memory 1310, in one embodiment, is a computer readable storage medium. In some embodiments, the memory 1310 includes volatile computer storage media. For example, the memory 1310 may include a RAM, including DRAM, SDRAM, and/or SRAM. In some embodiments, the memory 1310 includes non-volatile computer storage media. For example, the memory 1310 may include a hard disk drive, a flash memory, or any other suitable non-volatile computer storage device. In some embodiments, the memory 1310 includes both volatile and non-volatile computer storage media.

In some embodiments, the memory 1310 stores data relating to supporting SL cooperative positioning in NLOS scenario. For example, the memory 1310 may store parameters, configurations, resource assignments, policies, and the like as described above. In certain embodiments, the memory 1310 also stores program code and related data, such as an OS or other controller algorithms operating on the network apparatus 1300, and one or more software applications.

The input device 1315, in one embodiment, may include any known computer input device including a touch panel, a button, a keyboard, a stylus, a microphone, or the like. In some embodiments, the input device 1315 may be integrated with the output device 1320, for example, as a touchscreen or similar touch-sensitive display. In some embodiments, the input device 1315 includes a touchscreen such that text may be input using a virtual keyboard displayed on the touchscreen and/or by handwriting on the touchscreen. In some embodiments, the input device 1315 includes two or more different devices, such as a keyboard and a touch panel.

The output device 1320, in one embodiment, may include any known electronically controllable display or display device. The output device 1320 may be designed to output visual, audible, and/or haptic signals. In some embodiments, the output device 1320 includes an electronic display capable of outputting visual data to a user. Further, the output device 1320 may be a component of a smart phone, a personal digital assistant, a television, a table computer, a notebook (laptop) computer, a personal computer, a vehicle dashboard, or the like.

In certain embodiments, the output device 1320 includes one or more speakers for producing sound. For example, the output device 1320 may produce an audible alert or notification (e.g., a beep or chime). In some embodiments, the output device 1320 includes one or more haptic devices for producing vibrations, motion, or other haptic feedback. In some embodiments, all or portions of the output device 1320 may be integrated with the input device 1315. For example, the input device 1315 and output device 1320 may form a touchscreen or similar touch-sensitive display. In other embodiments, all or portions of the output device 1320 may be located near the input device 1315.

As discussed above, the transceiver 1325 may communicate with one or more remote units and/or with one or more interworking functions that provide access to one or more PLMNs. The transceiver 1325 may also communicate with one or more network functions (e.g., in the mobile core network 80). The transceiver 1325 operates under the control of the processor 1305 to transmit messages, data, and other signals and also to receive messages, data, and other signals. For example, the processor 1305 may selectively activate the transceiver (or portions thereof) at particular times in order to send and receive messages.

The transceiver 1325 may include one or more transmitters 1330 and one or more receivers 1335. In certain embodiments, the one or more transmitters 1330 and/or the one or more receivers 1335 may share transceiver hardware and/or circuitry. For example, the one or more transmitters 1330 and/or the one or more receivers 1335 may share antenna(s), antenna tuner(s), amplifier(s), filter(s), oscillator(s), mixer(s), modulator/demodulator(s), power supply, and the like. In one embodiment, the transceiver 1325 implements multiple logical transceivers using different communication protocols or protocol stacks, while using common physical hardware.

In one embodiment, the processor 1305 is configured to transmit a cooperative positioning request message to at least one reference device comprising a ranging or relative positioning request between the apparatus and a target device. In one embodiment, the processor 1305 is configured to receive at least one positioning quantity from the at least one reference device. In one embodiment, the processor 1305 is configured to determine ranging or relative position between the at least one reference device and the target device based on the received at least one positioning quantity.

In one embodiment, the processor 1305 is configured to transmit the cooperative positioning request message in response to determining a positioning quality metric between the apparatus and the target device is below a threshold.

In one embodiment, the positioning quality metric comprises at least one of LOS/non-LOS metric and a multipath detection metric.

In one embodiment, the processor 1305 is configured to receive SL positioning reference signals from the at least one reference device and transmit a positioning measurement report to the at least one reference device for determining at least a portion of the at least one positioning quantity.

In one embodiment, the ranging or relative positioning comprises distance and/or orientation between the apparatus and the target device.

In one embodiment, the at least one positioning quantity comprises an absolute position or a relative position of at least one of the apparatus or the target device.

In one embodiment, the at least one positioning quantity comprises a quantity based on RAT-dependent positioning techniques, RAT-independent positioning techniques or combination thereof.

In one embodiment, the processor 1305 is configured to receive information comprising at least Ref_ID parameter from a set of reference devices and determine the at least one reference device from the set of reference devices based on at least one of a priority level metric, a location of the at least one reference device, a channel condition between the apparatus and the at least one reference device.

In one embodiment, the processor 1305 is configured to receive at least one preferred reference device from the target device and determine the at least one reference device based on the received at least one preferred reference device.

In one embodiment, the processor 1305 is configured to transmit SL positioning reference signals to the target device and receive a positioning measurement report comprising the positioning quality metric from the target device.

In one embodiment, the processor 1305 is configured to receive a cooperative positioning request message from a network device comprising a ranging or relative positioning request between the network device and a target device. In one embodiment, the processor 1305 is configured to transmit at least one positioning quantity to the network device for determining ranging or relative position between the at least one reference device and the target device based on the received at least one positioning quantity.

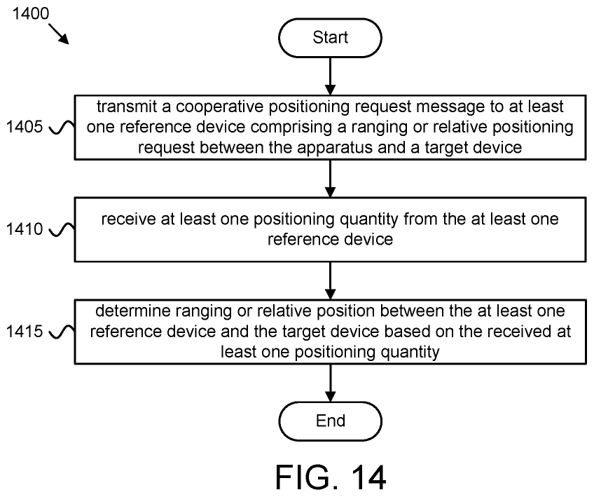

FIG. 14 is a flowchart diagram of a method 1400 for SL cooperative positioning in NLOS scenario. The method 1400 may be performed by a UE as described herein, for example, the remote unit 105 and/or the user equipment apparatus 1200, or a network device such as a base station, a roadside unit, or a network equipment apparatus 1300. In some embodiments, the method 1400 may be performed by a processor executing program code, for example, a microcontroller, a microprocessor, a CPU, a GPU, an auxiliary processing unit, a FPGA, or the like.

In on embodiment, the method 1400 begins and transmits 1405 a cooperative positioning request message to at least one reference device comprising a ranging or relative positioning request between the apparatus and a target device. In one embodiment, the method 1400 receives 1410 at least one positioning quantity from the at least one reference device. In one embodiment, the method 1400 determines 1415 ranging or relative position between the at least one reference device and the target device based on the received at least one positioning quantity, and the method 1400 ends.

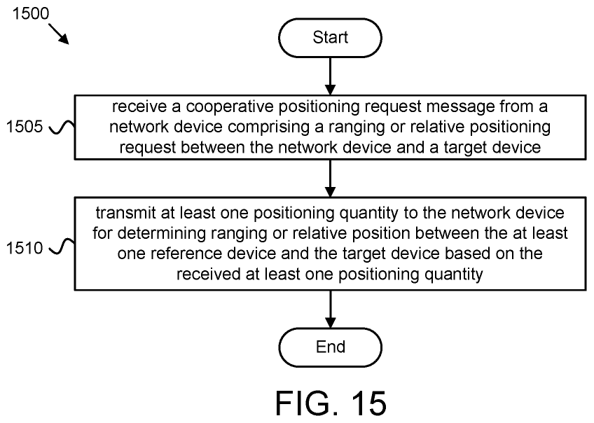

FIG. 15 is a flowchart diagram of a method 1500 for SL cooperative positioning in NLOS scenario. The method 1500 may be performed by a UE as described herein, for example, the remote unit 105 and/or the user equipment apparatus 1200, or a network device such as a base station, a roadside unit, or a network equipment apparatus 1300. In some embodiments, the method 1500 may be performed by a processor executing program code, for example, a microcontroller, a microprocessor, a CPU, a GPU, an auxiliary processing unit, a FPGA, or the like.

In one embodiment, the method 1500 begins and receives 1505 a cooperative positioning request message from a network device comprising a ranging or relative positioning request between the network device and a target device. In one embodiment, the method 1500 transmits 1510 at least one positioning quantity to the network device for determining ranging or relative position between the at least one reference device and the target device based on the received at least one positioning quantity, and the method 1500 ends.

A first apparatus is disclosed for SL cooperative positioning in NLOS scenario. The first apparatus may include a UE as described herein, for example, the remote unit 105 and/or the user equipment apparatus 1200, or a network device such as a base station, a roadside unit, or a network equipment apparatus 1300. In some embodiments, the first apparatus may include a processor executing program code, for example, a microcontroller, a microprocessor, a CPU, a GPU, an auxiliary processing unit, a FPGA, or the like.

In one embodiment, the first apparatus includes a memory and a processor coupled to the memory. In one embodiment, the processor is configured to cause the apparatus to transmit a cooperative positioning request message to at least one reference device comprising a ranging or relative positioning request between the apparatus and a target device. In one embodiment, the processor is configured to cause the apparatus to receive at least one positioning quantity from the at least one reference device. In one embodiment, the processor is configured to cause the apparatus to determine ranging or relative position between the at least one reference device and the target device based on the received at least one positioning quantity.

In one embodiment, the processor is configured to transmit the cooperative positioning request message in response to determining a positioning quality metric between the apparatus and the target device is below a threshold.

In one embodiment, the positioning quality metric comprises at least one of LOS/non-LOS metric and a multipath detection metric.

In one embodiment, the processor is configured to receive SL positioning reference signals from the at least one reference device and transmit a positioning measurement report to the at least one reference device for determining at least a portion of the at least one positioning quantity.

In one embodiment, the ranging or relative positioning comprises distance and/or orientation between the apparatus and the target device.

In one embodiment, the at least one positioning quantity comprises an absolute position or a relative position of at least one of the apparatus or the target device.

In one embodiment, the at least one positioning quantity comprises a quantity based on RAT-dependent positioning techniques, RAT-independent positioning techniques or combination thereof.

In one embodiment, the processor is configured to receive information comprising at least Ref_ID parameter from a set of reference devices and determine the at least one reference device from the set of reference devices based on at least one of a priority level metric, a location of the at least one reference device, a channel condition between the apparatus and the at least one reference device.

In one embodiment, the processor is configured to receive at least one preferred reference device from the target device and determine the at least one reference device based on the received at least one preferred reference device.

In one embodiment, the apparatus comprises one of abase station, a roadside unit, or user equipment.

In one embodiment, the at least one reference device is one of a roadside unit, or user equipment.

In one embodiment, the processor is configured to transmit SL positioning reference signals to the target device and receive a positioning measurement report comprising the positioning quality metric from the target device.

A first method is disclosed for SL cooperative positioning in NLOS scenario. The first method may be performed by a UE as described herein, for example, the remote unit 105 and/or the user equipment apparatus 1200, or a network device such as a base station, a roadside unit, or a network equipment apparatus 1300. In some embodiments, the first method may be performed by a processor executing program code, for example, a microcontroller, a microprocessor, a CPU, a GPU, an auxiliary processing unit, a FPGA, or the like.

In one embodiment, the first method transmits a cooperative positioning request message to at least one reference device comprising a ranging or relative positioning request between the apparatus and a target device. In one embodiment, the first method receives at least one positioning quantity from the at least one reference device. In one embodiment, the first method determines ranging or relative position between the at least one reference device and the target device based on the received at least one positioning quantity.

In one embodiment, the first method transmits the cooperative positioning request message in response to determining a positioning quality metric between the apparatus and the target device is below a threshold.

In one embodiment, the positioning quality metric comprises at least one of LOS/non-LOS metric and a multipath detection metric.

In one embodiment, the first method receives SL positioning reference signals from the at least one reference device and transmit a positioning measurement report to the at least one reference device for determining at least a portion of the at least one positioning quantity.

In one embodiment, the ranging or relative positioning comprises distance and/or orientation between the apparatus and the target device.

In one embodiment, the at least one positioning quantity comprises an absolute position or a relative position of at least one of the apparatus or the target device.

In one embodiment, the at least one positioning quantity comprises a quantity based on RAT-dependent positioning techniques, RAT-independent positioning techniques or combination thereof.

In one embodiment, the first method receives information comprising at least Ref_ID parameter from a set of reference devices and determine the at least one reference device from the set of reference devices based on at least one of a priority level metric, a location of the at least one reference device, a channel condition between the apparatus and the at least one reference device.

In one embodiment, the first method receives at least one preferred reference device from the target device and determine the at least one reference device based on the received at least one preferred reference device.

In one embodiment, the network apparatus comprises one of a base station, a roadside unit, or user equipment.

In one embodiment, the at least one reference device is one of a roadside unit, or user equipment.

In one embodiment, the first method transmits SL positioning reference signals to the target device and receive a positioning measurement report comprising the positioning quality metric from the target device.

A second apparatus is disclosed for SL cooperative positioning in NLOS scenario. The second apparatus may include a UE as described herein, for example, the remote unit 105 and/or the user equipment apparatus 1200, or a network device such as a base station, a roadside unit, or a network equipment apparatus 1300. In some embodiments, the second apparatus may include a processor executing program code, for example, a microcontroller, a microprocessor, a CPU, a GPU, an auxiliary processing unit, a FPGA, or the like.

In one embodiment, the second apparatus includes a memory and a processor coupled to the memory. In one embodiment, the processor is configured to cause the apparatus to receive a cooperative positioning request message from a network device comprising a ranging or relative positioning request between the network device and a target device. In one embodiment, the processor is configured to cause the apparatus to transmit at least one positioning quantity to the network device for determining ranging or relative position between the at least one reference device and the target device based on the received at least one positioning quantity.

A second method is disclosed for SL cooperative positioning in NLOS scenario. The second method may be performed by a UE as described herein, for example, the remote unit 105 and/or the user equipment apparatus 1200, or a network device such as a base station, a roadside unit, or a network equipment apparatus 1300. In some embodiments, the second method may be performed by a processor executing program code, for example, a microcontroller, a microprocessor, a CPU, a GPU, an auxiliary processing unit, a FPGA, or the like.

In one embodiment, the second method receives a cooperative positioning request message from a network device comprising a ranging or relative positioning request between the network device and a target device. In one embodiment, the second method transmits at least one positioning quantity to the network device for determining ranging or relative position between the at least one reference device and the target device based on the received at least one positioning quantity.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a memory; and
a processor coupled to the memory, the processor configured to cause the apparatus to:
transmit a cooperative positioning request message to at least one reference device comprising a ranging or relative positioning request between the apparatus and a target device;
receive at least one positioning quantity from the at least one reference device; and
determine ranging or relative position between the at least one reference device and the target device based on the received at least one positioning quantity.

2. The apparatus of claim 1, wherein the processor is configured to:
transmit the cooperative positioning request message in response to determining a positioning quality metric between the apparatus and the target device is below a threshold.

3. The apparatus of claim 2, wherein the positioning quality metric comprises at least one of line of sight (“LOS”)/non-LOS metric and a multipath detection metric.

4. The apparatus of claim 1, wherein the processor is configured to:
receive sidelink (“SL”) positioning reference signals from the at least one reference device; and
transmit a positioning measurement report to the at least one reference device for determining at least a portion of the at least one positioning quantity.

5. The apparatus of claim 1, wherein the ranging or relative positioning comprises distance and/or orientation between the apparatus and the target device.

6. The apparatus of claim 1, wherein the at least one positioning quantity comprises an absolute position or a relative position of at least one of the apparatus or the target device.

7. The apparatus of claim 1, wherein the at least one positioning quantity comprises a quantity based on radio access technology (“RAT”)-dependent positioning techniques, RAT-independent positioning techniques or combination thereof.

8. The apparatus of claim 1, wherein the processor is configured to:
receive information comprising at least Ref_ID parameter from a set of reference devices; and
determine the at least one reference device from the set of reference devices based on at least one of a priority level metric, a location of the at least one reference device, a channel condition between the apparatus and the at least one reference device.

9. The apparatus of claim 8, wherein the processor is configured to:
receive at least one preferred reference device from the target device; and
determine the at least one reference device based on the received at least one preferred reference device.

10. The apparatus of claim 1, wherein the apparatus comprises one of a base station, a roadside unit, or user equipment (“UE”).

11. The apparatus of claim 1, wherein the at least one reference device is one of a roadside unit, or user equipment (“UE”).

12. The apparatus of claim 1, wherein the processor is configured to:
transmit sidelink (“SL”) positioning reference signals to the target device;
receive a positioning measurement report comprising the positioning quality metric from the target device.

13. A method, comprising:
transmitting a cooperative positioning request message to at least one reference device comprising a ranging or relative positioning request between a network apparatus and a target device;
receiving at least one positioning quantity from the at least one reference device; and
determining ranging or relative position between the at least one reference device and the target device based on the received at least one positioning quantity.

14. The method of claim 13, further comprising transmitting the cooperative positioning request message in response to determining a positioning quality metric between the network apparatus and the target device is below a threshold.

15. An apparatus, comprising:
a memory; and
a processor coupled to the memory, the processor configured to cause the apparatus to:
receive a cooperative positioning request message from a network device comprising a ranging or relative positioning request between the network device and a target device; and
transmit at least one positioning quantity to the network device for determining ranging or relative position between the at least one reference device and the target device based on the received at least one positioning quantity.
